(19) United States
(12) Patent Application Publication
(10) Pub. No.: US 2006/0286214 A1
(43) Pub. Date: Dec. 21, 2006

(54) Edible drinking straw

(76) Inventors: Sanford B. Weiss, Los Angeles, CA (US); Andrew I. Wolf, Los Angeles, CA (US)

Correspondence Address: STETINA BRUNDA GARRED & BRUCKER, 75 ENTERPRISE, SUITE 250, ALISO VIEJO, CA, 92656, US

(21) Appl. No.: 11/486,466

(22) Filed: Jul. 14, 2006

Related U.S. Application Data
(63) Continuation-in-part of application No. 10/196,883, filed on Jul. 17, 2002.

(51) Int. Cl. A23G 1/00

(52) U.S. Cl. 426/104

(57) ABSTRACT

An edible drinking straw for use in consuming beverages is disclosed. A first layer of a fruit film is coated with a zein solution, and spirally wound. Subsequent layers of the fruit film may be wound on the first layer, each subsequent layer being attached to the previous layer with an adhesive. The outer surface of the straw may be coated with the zein solution.

### CROSS-REFERENCE TO RELATED APPLICATIONS

The present application is a continuation-in-part of U.S. patent application Ser. No. 10/196,883, filed Jul. 17, 2002 and currently pending, the subject matter of which is wholly incorporated by reference herein.

### STATEMENT RE: FEDERALLY SPONSORED RESEARCH/DEVELOPMENT

Not Applicable

### BACKGROUND

1. Technical Field

The present invention relates generally to utensils for food and beverage consumption. More particularly, the present invention relates to food and beverage utensils composed of edible food products.

2. Related Art

Drinking straws are well-known and extensively utilized to consume beverages. Generally, drinking straws comprise an elongate cylindrical sleeve defining a lumen therein through which a liquid beverage can be channeled to a consumer's mouth and imbibed. Essentially, an opposed end of the straw is submerged within the beverage to be consumed, the latter of which is drawn upwardly there through via a vacuum force created by the user's mouth on the other opposed end of the straw.

The vast majority of drinking straws currently in use are manufactured from plastic. In this respect, most straws are manufactured through an extrusion process whereby straws are formed to have a desired length, cut, and thereafter packaged. Because such straws are made from plastic, however, there are a number of significant problems. For instance, by virtue of being formed from plastic, the straws are not biodegradable. Since such plastic straws are typically disposed of following use, it is a substantial source of pollution. Such feature is particularly problematic given the fact that straws are utilized only for short duration (i.e., the consumption of one beverage) and are ill-suited for reuse.

Along these lines, perhaps the most widespread use of drinking straws is for the consumption of soft drinks sold in convenience stores and fast food restaurants. While such establishments offer tremendous convenience, oftentimes the available food products are substantially deficient in essential nutrients. Indeed, most soft drinks comprise nothing more than carbonated beverages with high sugar content, containing only a slight fraction of natural fruit juice.

With consideration to the above described state of the art, there appear to be a number of needs to be addressed. Problems have been and continue to exist with respect to the use of conventional drinking straws as well as the generally nutrient-void beverages typically consumed therewith. In light of such shortcomings, it is clearly apparent that there is a substantial need for a nutritional food product or supplement, preferably in the form of a conventional drinking straw capable of functioning as a nutritional food product imparting essential nutrients while simultaneously functioning as a conventional straw. Moreover, there is a need for such a straw that can actually be utilized as a vehicle to enhance the flavor of a given beverage while at the same time imparting essential nutrients to be consumed. There is likewise a need for such a straw that can be alternatively molded into a variety of utensils for consuming food that themselves can be consumed, which thus pose no threat of pollution and the like. Further, there is a need for such straws to be resilient enough for a reasonable period of time such that drawing liquid therethrough in accordance with its intended use will not cause it to disintegrate.

Certain advancements in these areas have been made, as exemplified by the subject matter disclosed in related U.S. patent application Ser. No. 10/196,883, filed Jul. 17, 2002 and currently pending, the subject matter of which is wholly incorporated by reference herein. Nevertheless, other similar or related areas of the art are in need of improvements, for example, strength of the drinking straws, the present invention provides such improvements.

### BRIEF SUMMARY

The present invention specifically addresses and alleviates the above-identified deficiencies in the art. In this regard, the present invention is directed to an edible drinking straw for use in consuming beverages that can thereafter be consumed. According to a preferred embodiment, the straw comprises a film body component and a coating applied thereto. The film body component may be comprised of pureed fruit, a thickening agent, one or more flavorings, a cellulose component, and a sweetening agent. More particularly, the flavorings may include natural fruit flavoring, malic acid, and/or citric acid. The coating may include a gluten component, ethanol, and water. According to a preferred embodiment, the gluten component is zein. The film body may be formed into a tubular configuration by spirally winding the same, and the interior thereof may be covered with the coating. Multiple layers of the film body may be provided, with particular layers being adhered to another with an adhesive solution.

According to another aspect of the present invention, there is provided an edible drinking straw comprising a first fruit film layer in a tubular configuration. The first fruit film layer may define a first outer surface and a first inner surface, with the first inner surface coated with a zein solution. The second fruit film layer may be wrapped around the first fruit film layer. Additionally, the second fruit film layer may define a second outer surface and a second inner surface that is in an adjoining relationship with the first outer surface. There may also be a third fruit film layer wrapped around the second fruit film layer and the first fruit film layer. The third fruit film layer may define a third outer surface and a third inner surface. The third inner surface may be in an adjoining relationship with the second outer surface. The third outer surface may be coated with the zein solution.

In accordance with yet another aspect of the present invention, there is provided a method for producing an edible utensil. The method may begin with mixing a fruit puree, a thickening agent, a fruit flavoring, malic acid, citric acid, a cellulose component, and a sweetening agent to yield a fruit film base composition. Next, the method may include the step of extruding the fruit film base composition into a fruit film. Thereafter, the method may continue with applying a coating of a zein solution to the first film. Additionally, there may be provided a step of wrapping a first layer of the fruit film around a mandrel to produce a tubular sleeve. According to another embodiment, the method may include the step of wrapping a second layer of the fruit film around the tubular sleeve.

Thus, the present invention represents a substantial departure from and provides significant advantages over conventional drinking straws. The present invention is best understood with reference to the following detailed description read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a glass containing a beverage and an edible drinking straw therein, the straw being constructed in accordance with an embodiment of the present invention;

FIG. 2 is a perspective view of a strip of fruit film in a spiral winding configuration in accordance with the present invention;

FIG. 3 is a flowchart illustrating the steps for constructing the edible drinking straw;

FIG. 4 is a perspective view of a strip of fruit film wound on a carrier film disposed on a forming mandrel;

FIG. 5 is a perspective view of a first strip of fruit film wound on the forming mandrel, with a water adhesive being applied to a subsequent strip of fruit film for attachment to the first strip;

FIG. 6 is a perspective view of the first strip of fruit film wound on the forming mandrel and a zein adhesive being applied to the subsequent strip of firm for attachment to the first strip; and

FIG. 7 is a cross-sectional view of the edible drinking straw in accordance with one embodiment of the present invention.

### DETAILED DESCRIPTION

The detailed description set forth below is intended as a description of the presently preferred embodiment of the invention, and is not intended to represent the only form in which the present invention may be constructed or utilized. The description sets forth the functions and the sequence of steps for developing the invention. It is to be understood, however, that the same or equivalent functions and sequences may be accomplished by different embodiments that are also intended to be encompassed within the spirit and scope of the invention. It is further understood that the use of relational terms such as first and second and the like are used solely to distinguish one entity from another entity without necessarily requiring or implying any actual such relationship or order between such entities.

The present invention is directed to edible drinking straws and other types of edible eating utensils that can be readily consumed during or after the consumption of a beverage or food product. Advantageously, the drinking straw and utensils of the present invention can function as a nutritional food product capable of delivering any of a variety of nutritional supplements, such as vitamins, minerals, herbal extracts, or any other type of supplement known in the art. Moreover, the edible drinking straw and utensils of the present invention can be utilized to impart a desired flavor to a particular beverage or food product, especially with respect to fruit flavors and the like as discussed more fully below. Still further, the edible drinking straw and utensils of the present invention have the advantage of not only supplementing the nutritional value of a food or beverage consumed thereby, in particular fast food items and soft drinks, but also, do not pose any type of wasteful byproduct which must necessarily be discarded, as are most drinking straws and utensils formed from plastic materials that are often discarded following a single use.

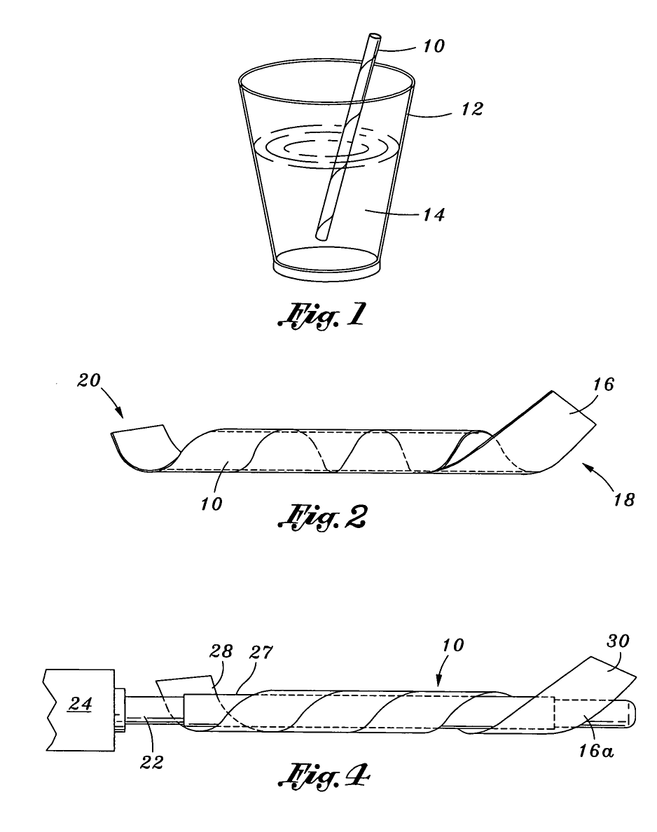

With reference to FIG. 1, an edible drinking straw 10 in accordance with the present invention is illustrated. As discussed above in relation to the background, the edible drinking straw 10 is typically placed inside a container 12 filled with a beverage 14, and by the user's muscular action, pressure within such user's mouth is reduced, and atmospheric pressure forces the beverage 14 up the straw 10. According to a preferred embodiment as shown in FIGS. 1 and 2, the edible drinking straw 10 is generally comprised of a thin strip of film 16 having a proximal end 18 and a distal end 20. The strip of film 16 is helically wound into a cylindrical tube. The specific techniques for constructing a straw in this manner is well known in the art and the skilled artisan will be able to readily ascertain and implement such techniques. Such an artisan will also recognize that numerous alternative techniques exist for the construction of the edible drinking straw 10 from the film 16, and any such technique or construction may be readily substituted for another without departing from the scope of the present invention.

According to a preferred embodiment, the constituent parts of the film 16 are ingredients imparting particular textural qualities and flavors. There is provided a pureed fruit, a thickening agent, a fruit flavoring, malic acid, citric acid, a cellulose component, and a sweetening agent. It is understood that while such specific ingredients are described herein, the present invention is not intended to be limited to such ingredients. Any other ingredient having like or equivalent qualities may be utilized in lieu of the preferred ingredients. For example, the pureed fruit may be a peach puree, the thickening agent may be pectin, and the flavoring agent, in order to match the flavor the peach puree, may be peach flavor. Additionally, the cellulose component may be SOLKA-FLOC®, and the sweetening agent may be sucralose, both of which are described in greater detail below.

The film 16 in accordance with one aspect of the present invention is composed of the aforementioned ingredients in the proportion as described in Table 1. It will be understood that the particular weights of the respective ingredients are presented by way of example in mass production settings only and not of limitation, and any suitable amount may be utilized, so long as the proportions as set forth are retained.

TABLE 1

| Ingredient | Weight (g) | Percentage |
|---|---|---|
| Peach Puree | 1000 g | 56.35% |
| Pectin | 710 g | 40.01% |
| Peach Flavor | 40.5 g | 2.28% |
| Malic Acid | 7.5 g | 0.42% |
| Citric Acid | 7.5 g | 0.42% |
| SOLKA-FLOC | 7 g | 0.39% |
| Sucralose | 2 g | 0.11 |
| Total | 1774.5 g | 100% |

As will be recognized by those having ordinary skill in the art, pectin is a heterosaccharide that may be utilized as an edible thickening agent. Under acidic conditions, pectin forms a gel, and is utilized in the film 16 to bind together the puree and the other components of the film 16. It is contemplated that the fruit puree is at a pH level sufficient to promote the gelling function of the pectin. While it is recognized that the peach fruit is rich in pectin, the additional pectin component, which according to a preferred embodiment is 40.0% by weight, is important for yielding the flexibly integral film 16. There are a number of techniques known in the art for deriving pectin, such as dissolving fruit pulp in hot water and precipitating as a gel with ethanol. However, the present invention contemplates the use of commercial preparations of pectin for simplifying the procedure of producing the film 16.

With respect to the fruit flavoring, as indicated above, the particular flavor may be selected to match the flavor of the pureed fruit component. It is understood that during processing of the film 16, the flavor of the fruit puree component may become diluted, and is one motivation for including further flavoring agents. As is well known in the art, the fruit flavoring may be extracted from the actual fruit, for example in the preferred embodiment, the peach flavoring may be extracted naturally from peach using well known techniques. However, due to the high production costs of natural flavoring, a chemically synthesized version may be readily substituted.

Further flavoring components may be incorporated in the film 16, such as malic acid and citric acid. More particularly, as will be recognized by a person of ordinary skill in the art, malic acid imparts a tart taste, while citric acid imparts a sour taste. The characteristics and the assumed form of both malic and citric acid are well known, as are its uses as food additives. For a flavor having greater impact, malic and citric acid concentrations may be increased.

As indicated above, the film 16 in accordance with an aspect of the present invention includes a cellulose component, preferably about 0.39% of the total weight. It will be understood that the cellulose component is derived from natural plant sources, and is conventionally utilized for imparting functional characteristics such as consistency, mouthfeel, strength, and structure upon the food product. As such, being limited to such use, the cellulose component is typically white, odorless, and flavorless. By way of example only, the cellulose component may be provided by International Fiber Corporation of North Tonawanda, N.Y., under the trade name SOLKA-FLOC®, and in a variety of fiber lengths from 15 to 300 microns. One of ordinary skill in the art will be able to select a fiber length depending on the desired characteristics, for correlating the fiber length and the functional characteristics are well known.

As indicated in Table 1, a sweetening agent may be incorporated into the film 16. In a preferred embodiment, such sweetening agent may be present in the amount of 0.11% or less by weight. To impart sweetness on the film 16 with such a low quantity, it will be appreciated that advanced sweeteners such as sucralose are necessary. Sucralose, given an equivalent amount, is approximately five hundred to six hundred times as sweet as regular sugar, or sucrose, twice as sweet as saccharin, and four times as sweet as asparatame, all of which are well-recognized sweeteners. Sucralose in its pure form is available from Tate & Lyle of Decatur, Ill. In addition to the highly sweet characteristics, it will be appreciated that the use of sucralose provides the additional benefit of having zero calories, improving the nutritional characteristics of the edible drinking straw 10. Since sucralose is not recognized by the human body as a sugar or as a carbohydrate, diabetics may utilize the edible drinking straw 10 as well.

In an optional, yet important aspect of the present invention, there may further be added one or more nutritional supplement components to further enhance the nutritional value of the edible drinking straws disclosed herein. In this respect, it is contemplated that any of a variety of nutritional supplements, including but not limited to, vitamins, minerals, herbal extracts, amino acids, or other types of dietary supplements, such as creatine and other types of functional and/or medicinal foods can be included within the ingredients utilized in the edible drinking straws of the present invention.

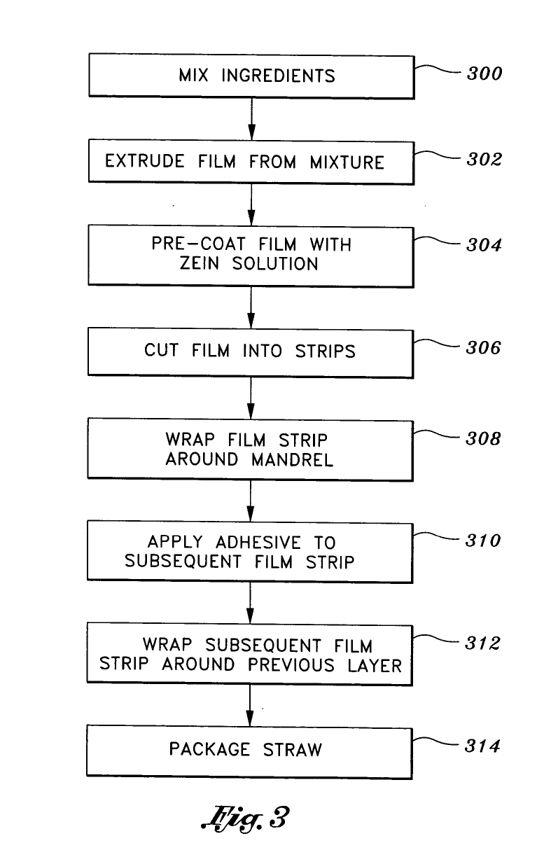

With reference to FIG. 3, in the method of forming the edible drinking straw according to the present invention, per step 300, the fruit puree, the thickening agent, the fruit flavoring, the malic acid, the citric acid, the cellulose component, and the sweetening agent are mixed together to result in a fruit film base composition. Next, according to step 302, the fruit film base composition is extruded and thin strips of the film 16 are formed. As will be understood by those having ordinary skill in the art, the machinery utilized to extrude the film 16 is well known in the art. Further, in conjunction with the extrusion process, the film 16 may be dried. By way of example only, the temperature of such drying process may be set to be approximately 135 degrees Celsius, with the film 16 traveling through the drying process at a speed of approximately 0.225 meters per minute. There may also be a forced air component generated by a blower operating at about 1000 revolutions per minute. Prior to the drying process, the film 16 may be about 25 mils thick. According to a preferred embodiment, the completed film 16 is approximately 150 feet long, about 15 inches wide, and about 3 mils thick. It will be appreciated that the film 16 may be of any shape or size desired, and the particular dimensions set forth hereinabove are intended to be exemplary only, and not limiting.

After completing the extrusion process and resulting in the film 16, a coating is applied thereto. The particular composition of a first coating solution according to one embodiment of the present invention is shown in Table 2, while the composition of a second coating solution is shown in Table 3. In a preferred embodiment, both the first coating solution and the second coating solution contain zein powder. It will be appreciated that other coating solutions are possible, Along these lines, the first coating solution will be referred to as the “light zein” solution, and the second coating solution will be referred to as the “heavy zein” solution. Generally, both the light zein solution and the heavy zein solution includes approximately 33% or less by weight a zein, or gluten component, approximately 70% or less by weight ethanol, and approximately 15% or less by weight water.

TABLE 2

| Ingredients | Weight | Percentage |
|---|---|---|
| Zein Powder | 600 g | 20% |
| Ethanol | 2040 g | 68% |
| De-ionized Water | 360 g | 12% |
| Totals | 3000 g | 100% |

TABLE 3

| Ingredients | Weight | Percentage |
|---|---|---|
| Zein Powder | 1137.5 g | 32.5% |
| Ethanol | 2008.1 g | 57.38% |
| De-ionized Water | 354.4 g | 10.13% |
| Totals | 3500 g | 100% |

It is well known in the art that zein is a water-insoluble class of prolamine protein found in corn. However, alternative embodiments contemplate the use of soy and whey derived proteins. It is generally understood to be a substitute for insect shellac, and has been used for coating candy, nuts, fruit, pills, and other encapsulated foods and drugs, because it is generally recognized as safe for human consumption by the USDA, and has additional beneficial characteristics such as fast-drying and long shelf-life. Pure zein is clear, hard, odorless, and for the most part, tasteless. While zein is insoluble in either one of water or alcohol, it is soluble in the mixture of the two. Thus, as shown in Tables 2 and 3, the zein solution is comprised of a part of zein powder and a part of ethanol and water. It will be appreciated that while zein provides excellent barrier properties, there may be some unpleasant flavor and mouthfeel characteristics associated therewith. In order to resolve such issues, other embodiments may include flavoring incorporated into the zein solution.

With reference to FIG. 3, according to step 304, the film 16 is pre-coated with the zein solution as set forth above, utilizing a commercial coater such as the Labcoater II system from O'Hara Manufacturing, LTD. of Toronto, Canada. For applying the light and heavy zein solutions, the conditions were: the temperature, 80 degrees Celsius; the IR top, 30% and bottom, 30%; web speed, 0.55 m/minute; air velocity, 1500 RPM; and wet thickness, 8 mils.

Following extrusion and pre-coating, the film 16 with the coating is cut with razor blades according to step 306. As indicated above, following the extrusion step the film 16 is approximately 15 inches wide and 150 feet long, and the cutting step 306 divides the film 16 into four strips at ⅞ of an inch wide, and 14 strips at ¾ of an inch wide. With reference to FIG. 4, the ¾ inch wide strip is used as a base layer 16a, and according to step 308, is wrapped around a forming mandrel 22 on a conventional spiral winding machine 24. According to a preferred embodiment, the base layer 16a may be wrapped around a carrier film 27 that is pre-wrapped around the forming mandrel 22. The carrier film 27 is preferably constructed of Mylar or paper, and may include printed information such as a logo, product information, cartoons, jokes, or games. It will be appreciated that the carrier film 27 provides an additional moisture barrier for preserving structural integrity until actual use, and enhances the removability of the edible drinking straw 10 from the forming mandrel 22 during manufacture. As a further enhancement or in the alternative, the forming mandrel 22 may be continuously fed with food grade lubrication oil, or slip agents may be added to the zein pre-coating. In addition to the proximal and distal ends 18 and 20, the base layer 16a defines an interior surface 28 and an exterior surface 30 of the edible drinking straw 10. In this regard, it is understood that the surface having the zein solution coated thereon is the interior surface 28.

According to another aspect of the present invention, it is expressly contemplated that additional layers, preferably of the ¾ inch wide strips, are formed on the base layer 16a described above. In order to attach such subsequent layers to the base layer 16a, a number of alternative adhesive compounds and application methods have been considered. With respect to the adhesive compound, water may be utilized, as well as hydrogenated starch hydrosylates. Additionally, gum Arabic (40% solids) may be utilized, as well as a variation of the zein coating solution described above. In this regard, a zein solution having 25% solids in a solution having 85% isopropyl alcohol and 15% water has been contemplated, and has been identified as the preferred adhesive.

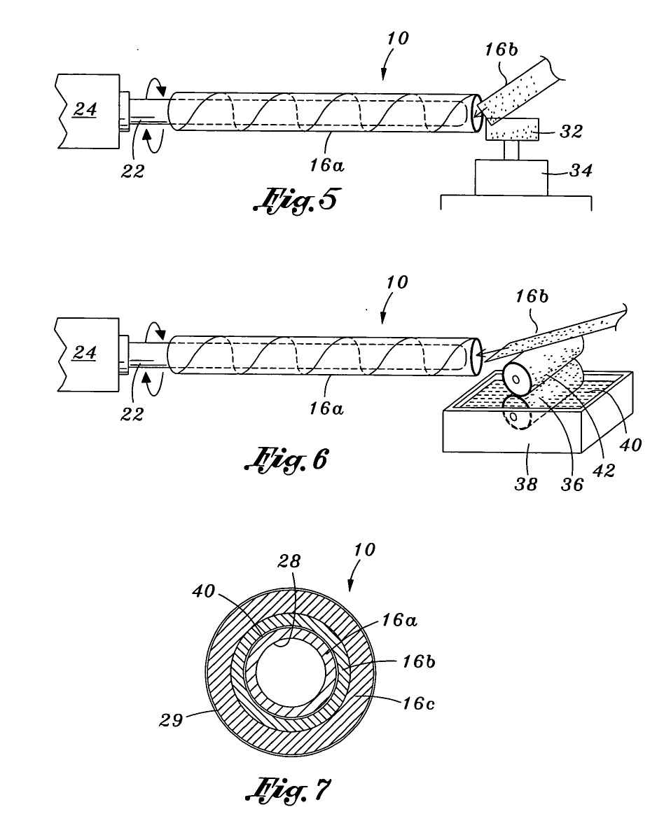

With regard to the use of water as an adhesive, it has been identified that the film 16 disintegrates or becomes severely weakened upon the application of the same. Referring to FIG. 5, after forming the base layer 16a on the mandrel 22, an additional upper layer 16b is formed. A heavy felt 32 may wick water from a reservoir 34, and the upper layer 16b is pulled over the felt 32 so that the film 16 will not degrade before being wound and moved down the mandrel 22.

In using other adhesives, in particular the zein solutions, as indicated above, a number of application methods have been contemplated. According to one embodiment, an atomizing spray to apply the zein solution has been contemplated. According to another embodiment, the film 16 is immersed in the adhesive, where an applicator pulls the film 16 into a batch of adhesive. The excess adhesive is gently scraped off as the film is fed to the mandrel 22. Additionally, according to a preferred embodiment, a powered roller has been contemplated for the application of adhesive to the film 16 as shown in FIG. 6. A first roller 36 is disposed within a basin 38 containing an adhesive solution 40. A second roller 42 is rotatably engaged to the first roller 36, and the adhesive 40 covering the first roller 36 is transferred to the second roller 42. The upper layer 16b rides on the second roller 42 and the adhesive 40 is transferred thereto.

With reference again to FIG. 3, in step 312, subsequent layers of the film 16 are wound onto the base layer 16a according to the methods described above. It is understood that the base layer 16a is formed with the ¾ inch wide strip. As illustrated in FIG. 7, the base layer 16a is defined by an interior surface 28 pre-coated with the zein solution as previously explained. A subsequently formed layer, second layer 16b, may also be formed with the ¾ inch wide strip. According to the preferred embodiment, the second layer 16b does not include pre-coating with the zein solution. However, prior to attachment to the base layer 16a, the second layer 16b may be applied the adhesive solution 40 as indicated above. The last layer, an outer layer 16c, is understood to be formed with the ⅞ inch wide strip for providing overlap on the film edges and enhances the stiffness of the edible drinking straw 10. Additionally, an outer surface 29 of the outer layer 16c may also be pre-coated with the zein solution in accordance with the composition described above, improving strength and water resistance. Along these lines, it is contemplated that each of the layers 16a, 16b, and 16c may be pre-coated with the zein solution, in addition to the use of the adhesive solution 40.

It will be apparent to those having ordinary skill in the art that various combinations using certain layers pre-coated and not pre-coated with the zein solution, certain layers affixed to another layer using adhesive, and varying number of layers, and so forth, are possible. It is expressly contemplated that each such combination is deemed to be within the spirit and scope of the present invention, but the following exemplary configurations have proven to be the most fruitful, exhibiting ideal characteristics of strength, adhesion between the layers, and water resistance.

### EXAMPLE 1

A base layer of the film pre-coated with light zein solution, a second layer of the film pre-coated with light zein solution, and an outer layer of the film pre-coated with the light zein solution. Prior to forming the subsequent layers, the zein adhesive solution is applied to the outer surfaces of the respective layers. This configuration resulted in straws suitable for intended use.

### EXAMPLE 2

A base layer of the film pre-coated with the light zein solution, a second layer of the bare film, a third layer of the bare film, and an outer layer of the film pre-coated with the light zein solution. The zein adhesive solution is applied to the outer surface of the third layer only. This configuration resulted in straws having excellent strength characteristics.

### EXAMPLE 3

A base layer of the film pre-coated with the light zein solution, and at least five layers of the bare film, including the outer layer. No adhesive was utilized to attach any of the layers to the other. This configuration resulted in straws suitable for intended use.

It will be understood that all of the inner layers are of the ¾ inch width variety, and each exemplary instance of the outer layer is of the ⅞ inch width variety, for reasons explained above. It is further understood that the zein pre-coating is applied during the manufacture of the individual strips of film, and is formed on the surfaces of what will become the interior-oriented surface of the edible drinking straw 10. However, the zein adhesive solution, which as indicated above is formulated using an alternative proportion of zein powder, ethanol, and water, are applied to the exterior-oriented surface of the edible drinking straw 10.

Once formed, the edible drinking straw 10 may then be packaged according to step 314 as depicted in the flowchart of FIG. 3. To this end, the product is packaged in any of a variety of conventional packaging materials having a good moisture barrier to prevent the product from rehydrating. In this respect, it is expressly contemplated that the straws of the present invention should be hermetically sealed using a proper moisture barrier film, which may be selected from any of a wide variety of films commercially available.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

What is claimed is:

1. An edible utensil comprising:
a film body component comprising:
approximately 60% or less by weight a pureed fruit;
approximately 45% or less by weight a thickening agent;
approximately 3% or less by weight a fruit flavoring;
approximately 1% or less by weight malic acid;
approximately 1% or less by weight citric acid;
approximately 1% or less by weight a cellulose component; and
approximately 1% or less by weight a sweetening agent;
a coating applied to the film body component, the coating comprising:
approximately 33% or less by weight a gluten component;
approximately 70% or less by weight ethanol; and
approximately 15% or less by weight water.

2. The edible utensil of claim 1, wherein the film body component is approximately 3 mils.

3. The edible utensil of claim 1, wherein:
the pureed fruit is approximately 56% by weight;
the thickening agent is approximately 40% by weight;
the natural fruit flavoring is approximately 3% by weight;
the malic acid is approximately 0.4% by weight;
the citric acid is approximately 0.4% by weight;
the cellulose component is approximately 0.4% by weight; and
the sweetening agent is approximately 0.1% by weight.

4. The edible utensil of claim 1, wherein the gluten component is zein.

5. The edible utensil of claim 1, wherein the gluten component is present in the amount from 20% to 33% by weight.

6. The edible utensil of claim 1, wherein the film body component is shaped in a tubular configuration and defines an outer tube surface and an inner tube surface.

7. The edible utensil of claim 6, wherein the tubular configuration is defined by the film body component being spirally wound.

8. The edible utensil of claim 6, wherein the coating is applied to the inner tube surface.

9. The edible utensil of claim 6, wherein the tubular configuration includes multiple layers of the film body component.

10. The edible utensil of claim 9, wherein at least one layer of the film body component includes a pre-applied layer of the coating.

11. An edible drinking straw, comprising:
an first fruit film layer in a tubular configuration defining a first outer surface and a first inner surface coated with a zein solution;
a second fruit film layer wrapped around the first fruit film layer, the second fruit film layer defining a second outer surface and a second inner surface in an adjoining relationship with the first outer surface;
a third fruit film layer wrapped around the second fruit film layer and the first fruit film layer, the third fruit film layer defining a third outer surface and a third inner surface in an adjoining relationship with the second outer surface, the third outer surface being coated with the zein solution.

12. The edible drinking straw of claim 11, wherein the zein solution comprises:
approximately 33% or less by weight a gluten component;
approximately 70% or less by weight ethanol; and
approximately 15% or less by weight water.

13. The edible drinking straw of claim 11, wherein the first fruit film layer, the second fruit film layer, and the third fruit film layer is comprised of:
approximately 60% or less by weight a pureed fruit;
approximately 45% or less by weight a thickening agent;
approximately 3% or less by weight a fruit flavoring;
approximately 1% or less by weight malic acid;
approximately 1% or less by weight citric acid;
approximately 1% or less by weight a cellulose component; and
approximately 1% or less by weight a sweetening agent;

14. The edible drinking straw of claim 11, wherein the first and second fruit film layers are each three quarters of an inch wide, and the third fruit film layer is seven eighths of an inch wide.

15. The edible drinking straw of claim 11, wherein the second fruit film layer is attached to the first fruit film layer with an adhesive.

16. A method for producing an edible utensil, the method comprising the steps of:
a. mixing a fruit puree, a thickening agent, a fruit flavoring, malic acid, citric acid, a cellulose component, and a sweetening agent to yield a fruit film base composition;
b. extruding the fruit film base composition into a fruit film;
c. applying a coating of a zein solution to the fruit film; and
d. wrapping a first layer of the fruit film around a mandrel to produce a tubular sleeve.

17. The method of claim 16, further comprising the step of:
e. wrapping a second layer of the fruit film around the tubular sleeve.

18. The method of claim 17, wherein step d includes immersing the second layer in a vat of the zein solution.

19. The method of claim 17, wherein step d includes rolling the second layer on a cylindrical applicator having the zein solution.

20. The method of claim 16 wherein the first layer is spirally wound on the mandrel.
